(19) United States
(12) Patent Application Publication
(10) Pub. No.: US 2018/0250719 A1
(43) Pub. Date: Sep. 6, 2018

(54) DEVICE AND METHOD FOR PROVIDING A CLEANING FLUID

(71) Applicant: Wiesheu GmbH, Grossbottwar (DE)

(72) Inventors: Falko DROEGE, Oppenweiler (DE); Joachim OSSWALD, Weinstadt (DE); Florian BRAUN, Kirchberg an der Murr (DE)

(21) Appl. No.: 15/905,971

(22) Filed: Feb. 27, 2018

(30) Foreign Application Priority Data
Mar. 3, 2017 (DE) 10 2017 104 492.2

(51) Int. Cl. B08B 3/08; B08B 3/02; B08B 3/10; G01N 9/26

(52) U.S. Cl. CPC B08B 3/08; G01N 9/26; B08B 3/104; B08B 3/02

(57) ABSTRACT

A device for providing at least one cleaning fluid, having a collecting container which by means of a pump and a fluid line is connected to a first cleaning container within which there is received a first cleaning component, further comprising a sensor unit and a control unit for controlling the pump and for interrupting a fluid loop depending on a concentration measured by the sensor unit in a contactless way.

This application claims priority from German patent application 10 2017 104 492, filed on Mar. 3, 2017. The entire content of this priority application is incorporated herein by reference.

### BACKGROUND OF THE INVENTION

The invention relates to a device and a method for providing at least one cleaning fluid, comprising a collecting container being connected via a pump and a fluid line to a first cleaning container within which a first cleaning component is received, further comprising a sensor unit and a controller unit for controlling the pump and/or the feeding of the cleaning component into the collecting container depending on a concentration measured by the sensor unit.

Such devices and methods for producing cleaning fluids from solid cleaning components are well known in the prior art, e.g. from WO 2011/157298 A1.

From WO 2011/157298 A1 a dosing device as well as a method for providing a cleaning fluid are known. The dosing device generates the cleaning fluid by dissolving a solid cleaning component. The dosing device herein is configured so that a measuring unit measures the conductivity of the cleaning fluid and thereby detects the concentration of the cleaning fluid.

The cleaning fluid is an aggressive solvent having a pH value between 13 and 14. During the measurement of the conductivity in such a solution inevitably measuring inaccuracies occur. Due to the aggressive cleaning fluid the surface of the conductance electrodes can be attacked and destroyed, since the latter are located within the cleaning fluid. Suitable electrodes which are chemically inert so that they also yield reliable results within a strongly basic environment, for instance are made of platinum and are very expensive to procure. In addition permanent maintenance costs occur. Moreover the conductance of a NaOH solution becomes asymptotic with increasing concentration so that also thereby the precision of the measurement is impaired. In addition in this device the cleaning fluid is generated directly fresh fully automatically before the application, which requires a communication with the devices connected therewith and thus impairs the flexibility when selecting the devices to be served with the cleaning solution.

In addition from DE 10 2014 202 430 A1 a further dosing device and a further method for providing a cleaning fluid are known. This dosing device generates the cleaning fluid by dissolving a solid cleaning component. This dosing device does not have any means for measuring concentration. Alternatively, herein a preselected concentration of the cleaning fluids is obtained by controlling the dissolving operation of the solid cleaning component by means of time.

A disadvantage of this device rests in the fact that for generating a cleaning fluid with a defined concentration solid cleaner is sprayed under time control. Due to the dependence of the dissolving rate of the solid cleaning component from the environmental temperature and moisture, a dissolving process controlled merely by time does not lead to the desired precision of the concentration of the cleaning fluid. In this way it cannot be ensured, whether the concentration of the cleaning fluid corresponds to a set concentration.

### SUMMARY OF THE INVENTION

In view of this it is a first object of the invention to disclose a device whereby a cleaning fluid having a preselected concentration can be provided in a particularly simple and reliable way.

It is a second object of the invention to disclose a method whereby a cleaning fluid having a preselected concentration can be provided in a particularly simple and reliable way.

It is a third object of the invention to disclose a device and a method whereby a cleaning fluid having a preselected concentration can be provided in a particularly simple and reliable way without any corrosion of any probe head.

According to one aspect of the invention this object is achieved by a device for providing a cleaning fluid, comprising:

a collecting container for collecting cleaning fluid;

a first cleaning container holding a first cleaning component and being in fluid connection to said collecting container;

a pump;

a fluid line being connected via said pump to said collecting container within a loop;

a sensor unit being configured for contactless concentration measurement of said cleaning fluid;

a control unit for controlling at least a feeding of cleaning component from said first cleaning container into said collecting container depending on a concentration of said cleaning fluid measured by means of said sensor unit.

The object of the invention if fully solved in this way.

According to the solution provided by the invention the concentration of the cleaning fluid can preferably be detected in a safe way without effecting any contact between the sensor unit and the aggressive cleaning fluid. In this way it is ensured that the surface of the sensor unit does not corrode due to the aggressive cleaning fluid and/or is damaged thereby. According to the invention a “contactless concentration measurement” is a measurement by means of which the sensor unit measures the concentration through a wall or another separating means, such a membrane.

In a preferred development of the invention the sensor unit is provided at the outer wall of the collecting container.

In a further preferred configuration the sensor unit may also be provided at the outer wall of the fluid line.

The concentration measurement may be performed on the cleaning fluid within the collecting container as well as on the cleaning fluid within the fluid line, since these are identical within the scope of measuring preciseness.

By means of the sensor unit contactless measurements of different parameters of a solvent within a collecting container or within the fluid line are performed. From these parameters thereafter the concentration of dissolved cleaning component within a fluid can be determined. The parameters are characterized in that there are dependent from the concentration of dissolved cleaning component. By means of this measurement method the concentration can be determined reliably. The parameters may be absolute values or may be represented by a change within the parameter, i.e. a difference, without being necessary to measure an absolute value.

Preferably the sensor unit is configured so that a change of the hydrostatic pressure of the cleaning fluid, a change of the weight of the collecting container, a change of the capacity, a change of the refractive index, or a change of the velocity of sound can be determined. These parameters vary depending on the concentration of cleaning component within the fluid.

The preparation of the cleaning fluid with a preset concentration is obtained by dissolving a cleaning component within a fluid.

In a preferred embodiment of the invention the device according to the invention is configured so that the cleaning container is mounted head first on the collecting container of the device. If the cleaning container is arranged head first within the device according to the invention, such as by screwing it into the collecting container, then a fluid may wet the bottom side of the cleaning component and may dissolve it a little. The fluid is conveyed within a closed loop and is enriched by the dissolved cleaning component, until a cleaning fluid is obtained having a defined concentration of dissolved cleaning component. The dissolving of the cleaning component and/or the fluid circulation combined therewith can be interrupted as soon as the sensor unit registers that a preset concentration is reached. The interruption of the fluid circulation and/or of the feeding of new cleaning component is controlled by the controller unit. The latter preferably controls the pump as well as the feeding of cleaning component. The feeding of cleaning component can e.g. be interrupted by stopping the spraying of cleaning component by means of the cleaning fluid. Also the pump may be switched off. On the other hand in addition or alternatively the feeding of cleaning component can be interrupted.

If the feeding of dissolved cleaning component is interrupted, then the pump may continue to run and may still circulate the cleaning fluid within a closed loop. However, in this configuration it is impaired that the cleaning fluid dissolves further cleaning component. This embodiment has the advantage that by the circulation of the cleaning fluid there is a continuous mixing leading to a homogenous concentration. In addition it is avoided thereby that the dissolved cleaning component may precipitate from the cleaning fluid.

As within this invention disclosure a “concentration” is mentioned, always the concentration of the dissolved cleaning component within the fluid is conceived. By enriching the dissolved cleaning component within the fluid thus the concentration is changed.

According to the invention a “fluid” is an aqueous solution which does not contain any dissolved cleaning component. Preferably the fluid is water, more preferably water of a known density. By enriching dissolved cleaning component within the fluid, the fluid becomes a cleaning fluid. Preferably the cleaning fluid is received within the collecting container.

The “cleaning component” preferably is a solid package being present in solid form. In particular the cleaning component is a basic cleaning salt which easily can go into solution.

Advantageously the cleaning fluid can also be stored for a longer time and the concentration can be regularly determined. This is possible by the contactless configuration of the sensor unit. During the storage the concentration can be continuously be reviewed and can be adjusted, if necessary. The adjustment of the concentration can on the one hand be obtained by a further addition of fluid, in case the concentration of the cleaning fluid is above the preset concentration. A reason for the overshooting of the concentration could be the evaporation of the fluids or a precipitation of the cleaning component. On the other hand, if the concentration of the cleaning fluid is below the preset concentration, then further cleaning component can be dissolved by means of the solvent. This is effected by controlling the pump by means of the controller unit so that the fluid circulates within the fluid loop. In this way it can be ensured that always the predefined concentration is existent within the cleaning fluid.

According to a further configuration of the invention the device is configured so that it contains only the volume for a single cleaning of a device. To this end the cleaning fluid may be removed by means of an outlet, or the device can be directly connected to a device to be cleaned. To this end the cleaning fluid may be produced freshly or may be stored within the collecting container up to the final cleaning requirement.

According to a further development of the invention the collecting container has a larger volume so that enough cleaning fluid can be provided for performing several cleaning procedures, or for cleaning several devices at the same time, or one after the other. To this end the cleaning fluid can be stored within the collecting container and can be removed therefrom, if necessary. In this configuration the defined concentration can always be adjusted and, if necessary, readjusted by the sensor unit. Preferably the cleaning fluid is used for a fully automatic cleaning of devices that are configured for heat-treating foods, such as ovens, combi-steamers, dish washers and fully automatic coffee machines.

In a development of the invention the sensor unit comprises means for measuring the hydrostatic pressure.

In a preferred development of the invention the concentration is determined by measuring the hydrostatic pressure variation within the collecting container. The hydrostatic pressure varies by means of the dissolving of the cleaning component, so that from the measured pressure variation the concentration of the cleaning fluid can be derived.

Since the hydrostatic pressure depends, inter alia, from the height of the liquid level and the density of the solution to be measured, if one of these parameters is known, the respective other parameter can be determined.

For measuring at the lower end of the collecting container a measuring line filled with air can be connected that is guided above the maximum level of the liquid level, and to which a pressure sensor is connected. This in the simplest embodiment may be a pressure gauge.

Alternatively the weight of the collecting container can be measured which depends on the filling level and the density of the cleaning fluid (gravimetric measurement).

Herein the collecting container is hung-up vertically movable in such a way that a weight variation within the collecting container can be registered by the sensor unit being configured as a pressure sensor.

For instance by means of the measurement of the hydrostatic pressure initially the filling height and thereby the volume of the fluid within the collecting container can be determined. The fluid preferably is a fluid of known density. After the filling height and thereby also the volume has been determined within the collecting container, then the fluid can be conveyed within the loop, so that cleaning component is dissolved and enriched within the fluid. By the enrichment of the dissolved cleaning component the density within the fluid changes and thereby also the hydrostatic pressure within the collecting container or the weight of the collecting container, respectively. During the dissolving operation the volume remains almost equal, so that by the change in the hydrostatic pressure the density and thereby the concentration of the cleaning fluid can be determined.

The pressure sensor for the weight measurement of the collecting container or for measuring the hydrostatic pressure is for example configured as a piezo sensor, the output signal of which is fed to the control unit. As soon as the pressure reaches a predetermined threshold, preferably the pump switches off and simultaneously the further feeding of cleaning component from the cleaning container is stopped.

By means of these contactless concentration measurements, wherein the means for measuring the hydrostatic pressure are used, it is possible to determine the concentration of dissolved cleaning component within the fluid reliably, without exposing a probe head to the aggressive cleaning fluid.

According to a further configuration of the invention the sensor unit comprises means for measuring the capacity.

Herein in particular a change in the permittivity of the cleaning fluid to be measured is utilized. For this configuration the wall of the collecting container or of the fluid line preferably is electrically non-conductive, since the probe heads are applied to the outer wall of the collecting container or of the fluid line. In a preferred embodiment the wall is characterized by a “window” which defines a region within which the wall is non-conductive.

In the capacitive measurement at least two electrodes are utilized between which there is the measurement field which is influenced by the concentration of cleaning fluid provided therein. The two electrodes form the two plates of an electric capacitor. The two plates preferably are rigid. The capacity changes due to the variation in the concentration and the variation in the permittivity caused thereby.

In a preferred development the capacitive sensor comprises a shield electrode. Thereby also small variations in the concentration can be detected. The shield electrode surrounds the actual measuring electrode so that the inhomogeneous peripheral range of the electric field is shielded from the measuring electrode. Thereby an almost parallel electrical field having the known characteristic of an ideal plate capacitor between the measuring electrode and the surface to be measured can be generated.

The capacitive sensor preferably works with an RC oscillator circuit generating an electric alternating voltage. The oscillating circuit is closed via the measuring cell within which the cleaning fluid is received. By the change in the concentration of the cleaning fluid the capacity changes and influences the oscillating frequency.

According to a first design thereby the filling height of the fluid within the collecting container can be determined, based on the different permittivities of air and of the fluid, or cleaning fluid, respectively. For this design the probe head preferably is arranged at the wall within the upper third of the collecting container.

According to a second configuration the fluid line is used as a measuring cell, wherein the electrodes are arranged at the two opposite walls. In this way a variation of the capacity caused by the variation of the concentration of the circulating cleaning fluid directly influences the oscillating circuit closed across the measuring cell and thus changes the frequency thereof.

By means of these contactless concentration measurements, wherein means for measuring the capacity are utilized, it is possible to determine the concentration of dissolved cleaning component within the fluid reliably, without exposing the sensor unit to the aggressive cleaning fluid.

In a further configuration of the invention the sensor unit comprises means for measuring the refractive index.

In this configuration the concentration is determined by measuring the refractive index of the cleaning fluid. The refractive index changes depending on the concentration. Typically a refractometer is utilized, whereby the variation of the refraction angle is determined that depends on the refractive index.

The refractometer herein makes use of the dependency of the refractive index of the fluid from an enrichment by the dissolved cleaning component within the fluid.

In a preferred configuration an optical sensor determines the reflection of a light ray. The light ray may for instance come from an LED light source and is reflected after impinging onto the solvent to be measured.

In this preferred configuration the sensor unit preferably is located at the wall of the collecting container or at the wall of the fluid line. Preferably the wall at this region comprises a “window” through which the light is irradiated and can be measured. This window preferably consists of a transmissive material which does not absorb light. The sensor unit herein is not in contact with the cleaning fluid.

According to a further configuration of the invention the sensor unit comprises means for measuring the speed of sound within the cleaning fluid.

Herein the contactless concentration measurement is performed by means of measuring the speed of sound or the change in the speed of sound, respectively, depending on the concentration. Using this measurement method the concentration within a fluid is determined precisely and fast, since the speed of sound within a fluid depends on the concentration of the individual components. To determine the speed of sound, a sound pulse exerting from a sound transmitter is transmitted through the cleaning fluid, and the time is measured, at which the pulse reaches the sound receiver. Since the distance between the sound transmitter and receiver is constant by means of design, the speed of sound can be computed. From this again the concentration of the cleaning fluid can be determined.

Both the sound transmitter as well as the sound receiver are not in direct contact with the cleaning fluid. Preferably the transmitter and the receiver are located at the outer wall of the collecting container on opposite sides at equal height so that in this way there is provided a long measuring distance.

Preferably the wall at this location, where the transmitter and the receiver are located, comprises a membrane through which the sound pulse can be transmitted and received. The membrane preferably is formed of a chemically inert material. Preferably the material may consist of PTFE which is chemically inert and sufficiently flexible for transmitting sound pulses from the transmitter and to the receiver, respectively. Thus herein the transmitter and the receiver themselves are not in contact with the cleaning fluid.

According to a further development of the invention the device comprises a second cleaning container within which a second cleaning component is received.

According to the invention the second component may be identical in its composition to the first cleaning component. This leads to the advantage that a large amount of cleaning fluid can be produced. In addition the second cleaning component may serve a reserve so that it can be always ensured that sufficient cleaning fluid can be produced. In this configuration the device preferably is configured so that the fluid loop first extends through the first cleaning container, as long as the sensor unit does not register any concentration variation anymore. As soon as the first cleaning container does not comprise anymore cleaning component, since the latter has been fully dissolved by the fluid, then the control unit can switch over the fluid loop so that the second cleaning component from the second cleaning container is dissolved. This for instance may be reached by a valve control. By means of such a configuration it can be ensured that always within the collecting container there is a cleaning fluid with a defined concentration.

In an alternative embodiment the second cleaning component in its composition is different from the first cleaning component. This has the advantage that a cleaning fluid can be produced which consists of different cleaning components.

In a further preferred development the device may comprise two, three, four or even more cleaning containers.

In a further preferred development of the invention the collecting container and the cleaning container are separated from each other by means of a retention device, wherein the retention device preferably has solid retarding characteristics, and wherein the retention device preferably is configured as a membrane, as a sieve, or as a fabric.

During solution of the cleaning component larger fragments of cleaning component may be released. To avoid that larger amounts of cleaning components can reach the fluid, the retention device retains these larger amounts of cleaning component. Thereby it can be ensured that the concentration does not change in an undesired way.

In particular, by this configuration it is impeded that due to the gravity cleaning components may detach and fall into the cleaning fluid, in case the cleaning container is located head first on the collecting container.

According to a further configuration of the invention within the collecting container there is provided a mixing or stirring device.

This configuration is particularly advantageous, since during longer storage of cleaning fluid solid deposits, or precipitates, respectively. By means of a mixing or stirring device, for instance using a propeller, a tube wing, a blade wing, a mixing tube, a stirring rod, etc. the cleaning fluid is mixed so that a deposition of cleaning component, or a precipitation of cleaning component, respectively, can be impeded. In addition, by this device always a homogeneous cleaning fluid is provided.

According to a further development of the invention the fluid line comprises at least one nozzle for spraying against a cleaning component within the cleaning container, preferably from below.

According to a further development of the invention this design is configured so that the nozzle is located at an orifice of the fluid line. Herein the nozzle may be arranged so that it points into the direction of the cleaning container and that a spraying against the cleaning component and thereby a dissolving of the cleaning component can be ensured. Preferably the nozzle can be configured so that the spraying jet spouts in a cone-shape, point-by-point or even in a fan-shape.

According to a further configuration of the invention the device comprises a volume control unit.

This design has the advantage that it can be ensured that always a minimum amount of cleaning fluid is provided within the collecting container. The volume control unit may be configured so that is refills fluid into the collecting container, if the sensor unit detects an overshoot of the defined concentration, or in case a minimum volume of cleaning fluid is undercut. In addition, the volume control unit may be configured so that automatically new fluid is refilled into the collecting container, in case cleaning fluid is withdrawn for the cleaning of devices. In addition this configuration has the advantage that the filling volume can be determined. This may improve a precise computation of the concentration.

According to the invention the object in addition is solved by a method for providing at least one cleaning fluid for supplying a cleaning system, comprising the following steps:
(a) providing a fluid within a collecting container;
(b) circulating the fluid through the collecting container and the cleaning container within a loop;
(c) dissolving at least one cleaning component by means of the fluid, whereby the fluid is enriched with dissolved cleaning component and eventually the cleaning fluid is obtained;
(d) measuring the concentration of the cleaning fluid by means of a sensor unit in a contactless way; and
(e) interrupting the dissolving process in step (c), as soon as the sensor unit registers a predefined concentration of dissolved cleaning component within the fluid.

In this way the object of the invention is fully solved.

By means of the method provided by the invention the concentration of the cleaning fluid can be safely determined without that a probe head comes into contact with an aggressive cleaning fluid. The surface of the sensor unit in this way is not corroded by the aggressive cleaning fluid and/or damaged thereby. In addition by the method provided by the invention it can always be ensured that in the collecting container there is always a cleaning fluid having a particular concentration. In addition, it can be ensured by the invention that a sufficient amount of cleaning fluid with a defined concentration is provided so that the cleaning fluid can be generated according to demand and/or can be stored.

According to a further configuration of the method according to the invention there is performed a measurement of a weight change, a measurement of a change of the hydrostatic pressure, a measurement of a capacity change, a measurement of a change in the speed of sound, or a measurement of a change in the refractive index.

In this way by means of these measured parameters the concentration of the cleaning fluid can be determined. In addition possibly step (e) can be controlled thereby, so that always there is a cleaning fluid of a predefined concentration within the collecting container.

According to a further development of the invention there is performed a measurement of the solvent volume within the collecting container.

This configuration has the advantage that by means of the measurement of the solvent volume always it can be detected, whether there is a minimum volume of a cleaning fluid or fluid within the collecting container. Thereby it can be ensured that always cleaning fluid can be extracted from the collecting container for cleaning devices.

According to a further development of the invention the solution of at least some cleaning components is performed by spraying the fluid onto the surface of the cleaning component which rests within the cleaning container, preferably by spraying from below.

According to a further development of the invention the amount of provided cleaning fluid is regulated by controlling the providing of the fluid to provide a minimum volume of cleaning fluid.

According to this configuration fresh fluid is filled into the collecting container, as soon as a minimum volume of cleaning fluid is undercut. Thereafter a further solution of the cleaning component is performed, until the cleaning fluid is provided with the desired set concentration.

In this way it can be ensured that always a minimum volume of cleaning fluid is provided.

According to a further development of the invention the provided cleaning fluid is provided in an amount that is sufficient for cleaning at least one device which is configured for the heat treatment of food, in particular a stove or a combi-steamer.

It will be understood that the afore-mentioned features of the invention and the features to be explained hereinafter cannot only be used in the given combination but also in different combinations or independently, without leaving the scope of the invention.

### BRIEF DESCRIPTION OF THE DRAWINGS

Further features and advantages of the invention can be taken from the subsequent description of preferred embodiment with reference to the drawings. In the drawings show:

FIG. 1 a first schematic representation of the device according to the invention;

FIG. 2A a schematic representation of a capacitive sensor unit;

FIG. 2B a schematic representation of a sensor unit for measuring the speed of sound;

FIG. 2C a schematic representation of a refractive sensor unit;

FIG. 2D a schematic representation of a sensor unit for measuring the hydrostatic pressure within the collecting container; and

FIG. 3 a schematic representation of the device according to the invention, comprising a second cleaning component.

### DESCRIPTION OF PREFERRED EMBODIMENTS

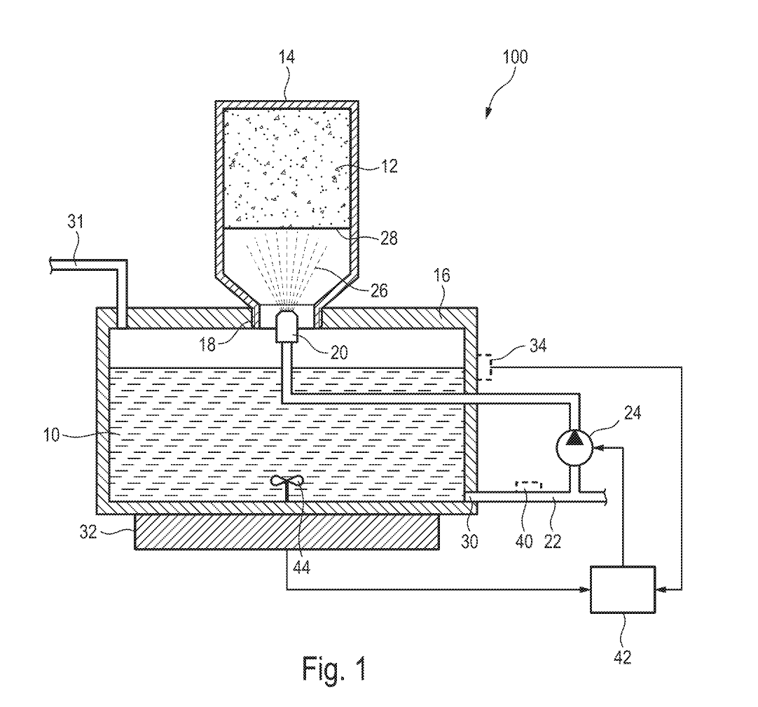

FIG. 1 shows a first device 100 according to the invention for providing at least one cleaning fluid 10.

The device 100 according to FIG. 1 comprises a cleaning component 12, which is received within a first cleaning container 14. The first cleaning container 14 with the cleaning component 12 received therein is held above the collecting container 16 within a receptacle 18. The receptacle 18 may for example be configured with inner threads and may be located at the top side of the collecting container 16. The cleaning container 14 may then be screwed with assigned outer threads into the inner threads. Of course there is also the possibility to design this connection in a different way, such as a click connection with locking means or with a positive connection.

The cleaning container 14 that is screwed into the collecting container 16 at its bottom side comprises an orifice through which a nozzle 20 pointing upwardly protrudes into the cavity below the cleaning component 12. The nozzle 20 herein is arranged at the collecting container 16. The nozzle 20 preferably is a spray nozzle. The nozzle 20 sprays cleaning fluid 10 being provided within the collecting container 16 into the cleaning container 14 onto the bottom side 28 of the cleaning component 12 which is dissolved thereby. According to the invention the fluid is an aqueous solution which initially does not contain any dissolved cleaning component 12. Preferably the fluid is configured as water. By enriching dissolved cleaning component 12 within the fluid, the fluid becomes the cleaning fluid 10.

During running of pump 24 by means of the nozzle 20 continuously a spray jet 26 is directed onto the bottom side 28 of the cleaning component 12. The fluid, or the cleaning fluid 10, respectively, sprayed onto the bottom side 28 of the cleaning component 12 herein partially dissolves the cleaning component 12 and flows back into the collecting container 16. Thereby the concentration of dissolved cleaning component 12 changes within the cleaning fluid 10 within the collecting container 16. The cleaning fluid 10 is pumped within a fluid loop via a fluid line 22, the nozzle 20, the cleaning container 14 and the collecting container 16, until there appears a defined set concentration within the cleaning fluid 10.

The solution of the cleaning component 12 and the fluid circulation connected therewith is interrupted as soon as an assigned sensor unit 32 configured as a pressure sensor registers the reaching of a predefined set concentration. The interruption of the fluid circulation or of the feeding of new cleaning component 12, respectively, is controlled by the control unit 42. The latter controls the pump 24. Since the nozzle 20 in the given design is activated only when the pump 24 is active, upon switching off the pump 24 also the feeding of cleaning component 12 is interrupted.

Optionally the collecting container 16 in addition comprises a mixing device 44. This mixing device 44 may be configured as a propeller, as a tube wing, as a blade wing, as a mixing tube, as a stirring rod or similar. The mixing device 44 mixes the cleaning fluid 10 within the collecting container 16. By this design a deposition of cleaning component 12 or a precipitation of cleaning component 12, respectively, is impeded. Thus, it is also avoided that the concentration within the cleaning fluid 10 changes during longer storage. Thus always a homogeneous cleaning fluid 10 can be provided having a defined set concentration.

FIG. 1 shows that the pump 24 is arranged within the fluid line 22 which starts at an outlet 30 at the bottom end of the collecting container 16 and ends with an orifice configured as a nozzle 20. By means of the pump 24 the cleaning fluid 10 being provided within the collecting container 16 is fed to the nozzle 20 which sprays against the bottom side of the cleaning component 28 and which may be configured as a fan-shape, a cone-shape or as a point-by-point spraying jet 26, so that cleaning component 12 dissolves within the cleaning fluid 10.

The device 100 according to FIG. 1 comprises a sensor unit 32 being configured as a pressure sensor, e.g. in the form of a piezo sensor, upon which the collecting container 16 rests. The sensor unit 32 is configured so that it can detect the weight of the collecting container 16 which is influenced by the hydrostatic pressure within the collecting container 16. The hydrostatic pressure changes by means of the solution of cleaning component 12 so that by means of the measured pressure change the concentration of the cleaning fluid may be derived. The volume during the solution process remains almost equal, so that by the variation of the hydrostatic pressure the density and thereby the concentration of the cleaning fluid 10 can be derived.

The collecting container 16 is arranged vertically movably so that a weight change of the collecting container 16 can be registered by the sensor unit 32.

The sensor unit 32 is connected with a control unit 42 which controls the pump 24. As soon as the sensor unit 32 registers a certain set pressure, the sensor unit 42 switches off the pump. In this way the feeding of fluid to the nozzle 20 ends so that no further cleaning component 12 is dissolved.

Alternative sensor units are shown exemplarily in FIG. 1 as a sensor unit 34 being configured as a capacitive sensor located at the wall of the collecting container 16 for filling level measurement, as well as a refractive sensor unit 40 at the fluid line 22, both shown in dashed lines.

The measurement principle of the contactless capacitive measurement relies on the variation of the capacity depending on the variation of the concentration of dissolved cleaning component 12 within the cleaning fluid 10. Herein in particular the different permittivities of the cleaning fluid 10 to be measured, are exploited.

The capacitive sensor unit 34 preferably is located at the wall of the collecting container 16 or at the two walls of the fluid line 22 facing each other. For this configuration the wall of the collecting container 16 or of the fluid line 22 is preferably electrically non-conductive, since otherwise measurement inaccuracies may occur. In a preferred design the wall may also comprise a “window” defining a region within which the wall is configured non-conductive. In addition the sensor unit 34 is not in direct contact with the cleaning fluid 10.

The capacitive sensor unit 34 comprises at least two electrodes between which the measurement field is provided which is influenced by the concentration of the cleaning fluid 10 provided therein. The two electrodes form the plates of a capacitor. Due to different permittivities and the different capacities caused thereby, the concentration can be determined.

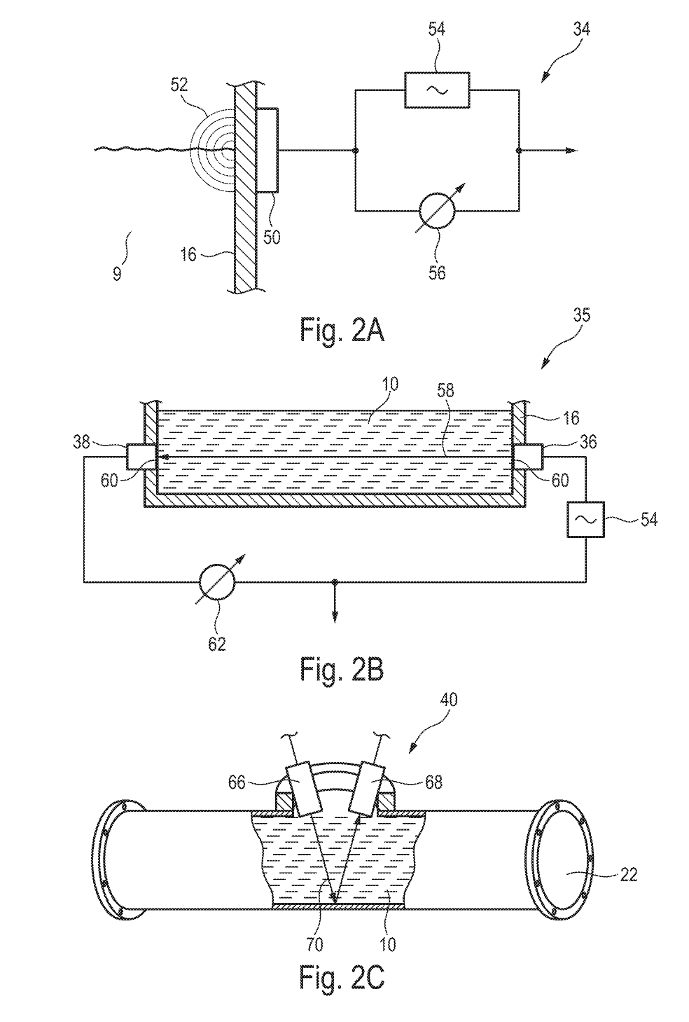

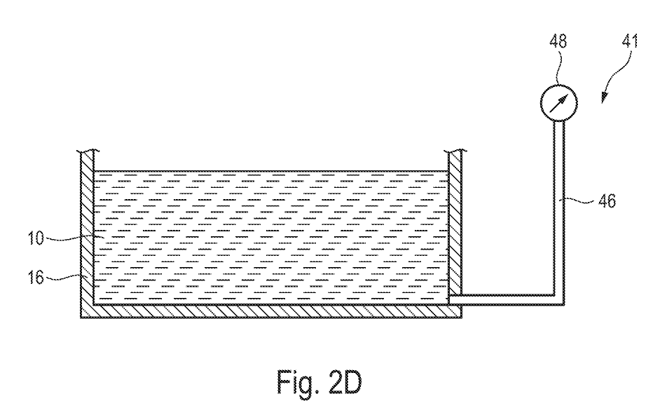

Preferably for the capacitive sensor unit 34 an oscillation circuit including an oscillator is utilized, the frequency of which is influenced by the cleaning fluid, as subsequently described with reference to FIG. 2A.

When the sensor unit 34 is located at the upper third of the collecting container 16, in this way the filling height of the fluid within the collecting container 16 can be detected directly. The sensor unit 34 reacts very sensitive to the variation of the filling height, due to the different permittivities of air and of the fluid, or the cleaning fluid 10, respectively.

FIG. 2A shows the schematic representation of a section of the sensor unit 34. This sensor unit 34 comprises a sensor electrode 50 which is mounted at the wall of the collecting container 16. To this end the wall is configured so that it does not disturb the capacitive measurement. This sensor electrode 50 generates an electrical field 52, the so-called active zone. The electric field 52 preferably is generated by means of an oscillation circuit 54. The capacity between the active electrode 50 and the cleaning fluid 10 within the measuring cell 56 to be measured can be registered by means of the sensor electrode 50 and can be evaluated. By the change of concentration in the direct environment of the electric field 52 of the sensor 50 the capacity changes and thus influences the oscillation frequency of the oscillator. This is detected by means of a measuring unit 56 or directly by means of the controller 42 which preferably comprises a micro processor.

If the capacitive sensor unit 34 is attached to the fluid line 22, then the two electrodes are located at the two opposite walls. Thereby a variation in the capacity by the variation of the concentration of the circulating cleaning fluid 10 has a direct impact on the oscillating circuit closed via the measuring cell and thus changes the frequency thereof.

A further possible configuration of the sensor unit according to the invention is the concentration measurement by means of the speed of sound, as depicted in FIG. 2B by the sensor unit 35. Herein a transmitter 36 transmits a sound wave pulse through the collecting container 16 being measured by the receiver 38. By means of the measurement the running time of the sound pulse between the transmitter 36 and the receiver 38, or by measuring the phase difference between the transmitter signal and the receiver signal, respectively, the speed of sound can be computed. From this again the concentration of the cleaning fluid can be derived.

By means of calibrating solutions a calibrating speed of sound can be determined. As soon as this calibrating speed of sound is registered within the measuring cell 62, the control unit 42 can switch off the pump 24, or can interrupt the feeding of cleaning component 12 into the collecting container 16, respectively.

The sound waves 58 can be generated by means of an oscillating circuit 54. In a preferred configuration the transmitter 36 may be configured as a speaker, for example as piezo-electric quartz oscillator or ceramic oscillator. This may be fed with an alternating voltage with the self-resonance frequency or with a harmonic thereof.

The transmitter 36 as well as the receiver 38 are not in direct contact with the cleaning fluid 10, but are separated from cleaning fluid 10 for example by means of a membrane 60. This membrane 60 is configured so that the sound waves 58 can be transmitted and received. The membrane 60 preferably consists of a chemically inert material, such as PTFE, so that it cannot be attacked by the aggressive cleaning fluid 10.

The sent sound waves 58 may for instance be ultrasound waves which are transmitted by means of piezo sensors. With such a measurement method the concentration of the cleaning fluid 10 can be determined very precisely, since the speed of sound within a fluid depends on the concentration of the individual components.

Preferably, the transmitter 36 and the receiver 38 are located at the outer wall of the collecting container 16 on respectively opposite sides to each other, at the same height, so that in this way a long measuring distance is provided.

A further possible design of the sensor unit according to the invention is a refractive sensor unit 40 according to FIGS. 1 and 2C, respectively. Herein the concentration of dissolved cleaning component 12 within the fluid can be determined by means of measuring the refractive index within the cleaning fluid 10. The refractive index varies depending on the concentration. To this end a light source 66 transmits a light pulse which is totally reflected at the transparent wall of the fluid line 22. The reflected light ray is detected by means of the receiver 68.

Since the angle of total reflection depends on the refractive index of the cleaning fluid, therefrom the concentration of the cleaning fluid can be derived.

FIG. 2C shows a schematic representation of a section of the sensor unit 40 being configured as a refractometer.

The receiver 68 preferably is configured as an optical sensor. The transmitter 66 as well as the receiver 68 are located outside of the wall. The wall preferably is configured as the wall of the fluid line 22. The wall is configured so that it does not interrupt the light ray 70 undesirably or absorb the light rays 70. Preferably the wall at this region of the transmitter 66 and the receiver 68 comprises a transparent window.

By means of calibrating solutions the refractometer can be calibrated to a desired set concentration.

A further configuration of the sensor unit is shown in FIG. 2D and depicted in total with 41. This is a particularly simple and reliable measuring method by means of measuring the hydrostatic pressure at the bottom of the collecting container 16.

To this end at the bottom of the collecting container 16 there is arranged a measuring line 46 that is filled with air and that is guided upwardly beyond the maximum possible level of the liquid level within the collecting container 16. At the end of the measurement line 46 there is provided a pressure sensor 48. If the pressure sensor 48 detects the reaching of a particular threshold value, then the concentration of the cleaning fluid 10 has reached the given set concentration.

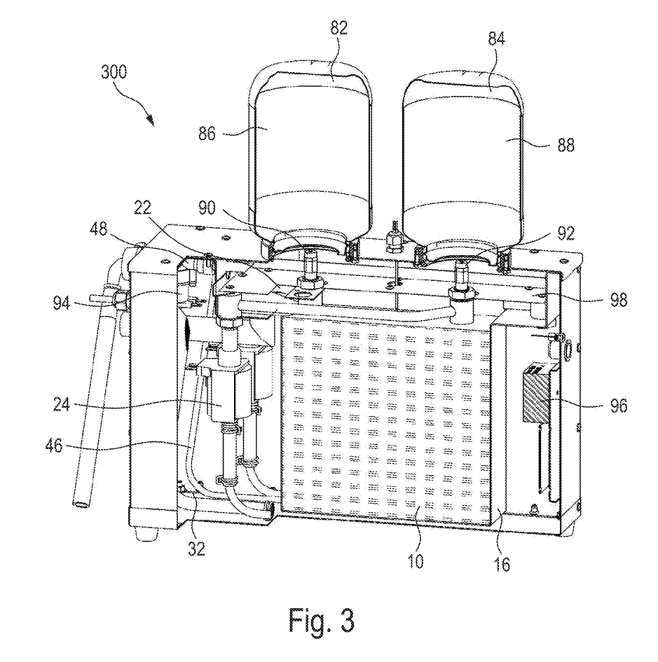

FIG. 3 shows a third device 300 according to the invention for providing at least one cleaning fluid 10.

The device 300 according to the representation in FIG. 3 comprises a first cleaning container 82 and a second cleaning container 84. These are mounted facing with their open side downwardly within the top of the collecting container 16. The first and second cleaning containers 82 and 84 comprise a first and a second cleaning component 86 and 88, for instance in block form. The respective bottom sides of the first and second cleaning components 86 and 88 are wetted by means of spraying jets emerging from a first nozzle 90 and a second nozzle 92, so that the cleaning components 86 and 88 are partially dissolved and can be dissolved within the cleaning fluid 10. The fluid from a first feed passes over to the first and second pump 24. The pumps 24 of the first nozzle 90 and of the second nozzle 92, respectively each pump cleaning fluid 10 by means of an assigned fluid line 22 into the assigned nozzles 90, 92, so that the bottom sides of the first and second cleaning components 86 and 88 are wetted. Herein the fluid line 22 may comprise interposed valves 94, preferably magnetic valves. The filling volume of the cleaning fluid 10 being located within the collecting container 16 can be controlled by means of a volume control 96.

Within the two cleaning containers 82 and 84 according to the representation in FIG. 3 two cleaning components 86 and 88 of equal composition may be located. Herein the second cleaning component 88 may serve as a reserve, so that always it can be ensured that enough cleaning fluid 10 can be made. In this configuration the device 300 is preferably configured so that the fluid loop initially passes through the first cleaning container 82 as long as the sensor unit 32 does not detect any change in concentration anymore. As soon as the first cleaning container 82 does not have any more cleaning component 86, since the latter has been fully dissolved by the cleaning fluid 10, then the control unit can switch over the fluid loop so that the second cleaning component 88 is dissolved from the second cleaning container 84. In this way it can be ensured that always within the collecting container 16 there is a cleaning fluid 10 with a defined concentration. The selection of the two nozzles 90 and 92 can be controlled by means of valves 94. The valves 94 preferably are configured as magnetic valves.

FIG. 3 further shows a retention device 98 which divides the cleaning components 86 and 88 from the collecting container 16 and the cleaning fluid 10 provided therein. Such a retention device 98 preferably has solid retarding characteristics. Such a retention device 98 may e.g. be configured as a membrane, as a sieve, or as a fabric.

When dissolving the cleaning component 86 and 88 there may occur a detachment of larger fractions of cleaning components 86 and 88. To avoid that larger amounts of cleaning components 86 and 88 get into the cleaning fluid 10, the retention device 98 retards these larger amounts of cleaning components 86 and 88. In this way it can be ensured that the concentration cannot change in an undesired way.

As soon as the cleaning fluid 10 reaches the defined set concentration, the pump 24 is stopped and the feeding of cleaning component 86 and 88, respectively, is interrupted.

The circulation of the cleaning fluids 10, in particular the dissolving of cleaning components 86 and 88, respectively, is controlled by means of the control unit 42 (not shown in FIG. 3) according to the information of the sensor unit 32. If the sensor unit 32 detects that within the collecting container 16 there is the set concentration, it forwards this information to the control unit 42 so that the control unit stops the circulation of the cleaning fluid 10. If the defined concentration has not been reached yet, the circulation of the cleaning fluid 10 continues.

According to FIG. 3 the hydrostatic pressure is measured by means of a measuring line 46 and a pressure sensor 48, as previously explained with reference to FIG. 2D.

What is claimed is:

1. A device for providing a cleaning fluid, comprising:
a collecting container for collecting cleaning fluid;
a first cleaning container arranged above said collecting container and holding a first cleaning component being in fluid connection to said collecting container;
a pump;
a fluid line being connected via said pump to said collecting container within a loop;
a sensor unit being configured for contactless concentration measurement by measuring hydrostatic pressure of said cleaning fluid;
a control unit for controlling at least a feeding of cleaning component from said first cleaning container into said collecting container depending on a concentration of said cleaning fluid measured by means of said sensor unit.

2. A device for providing a cleaning fluid, comprising:
a collecting container for collecting cleaning fluid;
a first cleaning container holding a first cleaning component and being in fluid connection to said collecting container;
a pump;
a fluid line being connected via said pump to said collecting container within a loop;
a sensor unit being configured for contactless concentration measurement of said cleaning fluid;
a control unit for controlling at least a feeding of cleaning component from said first cleaning container into said collecting container depending on a concentration of said cleaning fluid measured by means of said sensor unit.

3. The device of claim 2, wherein said cleaning container is arranged above said collecting container.

4. The device of claim 2, wherein said sensor unit is configured for measuring a weight of said collecting container.

5. The device of claim 2, wherein said sensor unit is configured for measuring a hydrostatic pressure of said cleaning fluid.

6. The device according to claim 2, wherein said sensor unit is configured for measuring an electric capacity within said cleaning fluid.

7. The device of claim 2, wherein said sensor unit is configured for measuring a refractive index of said cleaning fluid.

8. The device of claim 2, wherein said sensor unit is configured for measuring a speed of sound within said cleaning fluid.

9. The device of claim 2, characterized by a second cleaning container holding a second cleaning component.

10. The device of claim 2, wherein said collecting container and the cleaning container are separated from each other by a separator having solid retarding characteristics.

11. The device of claim 10, wherein said separator is selected from the group consisting of a membrane, a sieve, and a fabric.

12. The device of claim 2, further comprising a stirring device for stirring said cleaning fluid within said collecting container.

13. The device of claim 2, further comprising at least one nozzle fed with cleaning fluid from said pump through said fluid line for spraying cleaning fluid against a cleaning component within the cleaning container.

14. The device of claim 13, wherein said nozzle is arranged below a bottom side of said cleaning component within said cleaning container.

15. The device of claim 2, further comprising a separating wall arranged within said collecting container or said fluid line cooperating with said sensor unit for allowing said contactless concentration measurement of said cleaning fluid through said separating wall.

16. The device of claim 15, wherein said separating wall is configured as a flexible membrane.

17. The device of claim 2, wherein said control unit is configured for interrupting said feeding of cleaning component from said first cleaning container into said collecting container and for stopping said pump upon detecting a preset concentration of cleaning fluid within said collecting container.

18. A method for providing a cleaning fluid with a particular concentration, comprising the following steps:
(a) providing a fluid within a collecting container;
(b) circulating the fluid within a loop through said collecting container and a cleaning container;
(c) dissolving at least one cleaning component by means of said fluid, whereby said fluid is enriched with dissolved cleaning component and said cleaning fluid is obtained;
(d) detecting a concentration of said cleaning fluid in a contactless way; and
(e) interrupting said dissolving within step (c) as soon as a predefined concentration of dissolved cleaning component within said cleaning fluid is detected.

19. The method of claim 18, wherein a measurement is performed by measuring at least one selected from the group consisting of a weight of said collecting container, a hydrostatic pressure of said cleaning fluid within said collecting container, an electric capacity of said cleaning fluid within said collecting container, speed of sound of said cleaning fluid within said collecting container, and a refractive index of said cleaning fluid within said collecting container.

20. The method of claim 18, wherein a dissolving of at least one cleaning component is performed by spraying fluid from below onto a surface of said cleaning component being located within said cleaning container.
